(19) United States
(12) Patent Application Publication
(10) Pub. No.: US 2014/0157170 A1
(43) Pub. Date: Jun. 5, 2014

(54) Storytelling in Visual Analytics Tools for Business Intelligence

(71) Applicant: SAP AG, Walldorf (DE)

(72) Inventor: Micheline Elias, Levallois Perret (FR)

(73) Assignee: SAP AG, Walldorf (DE)

(21) Appl. No.: 13/705,005

(22) Filed: Dec. 4, 2012

(51) Int. Cl. G06F 3/048

(52) U.S. Cl. CPC G06F 3/048
USPC 715/771

(57) ABSTRACT

In one embodiment, a method creates a story from business intelligence visualizations. The method displays a set of visualizations associated with a business intelligence system on a business intelligence dashboard where the business intelligence dashboard is used to create a business intelligence report. Also, the method receives a set of annotations that are associated with one or more visualizations in the set of visualizations through the dashboard and stores the set of annotations with links to the one or more visualizations. Then, a narrative board is generated for the story including at least a portion of the visualizations and the set of annotations. The set of annotations on the narrative board are displayed visually in the narrative board with a visual relationship to respective visualizations based on respective links to the visualizations to form the story.

### BACKGROUND

An organization uses business intelligence (BI) to analyze data sets and convert them into knowledge that can be communicated, shared, and interpreted with others. With increasingly large data sets, BI experts use data visualization to convey the BI analysis. Certain BI systems, such as dashboards, provide a multi-chart interface where the user can explore multiple charts on the same user interface. The data sources for these charts may be different, which means each chart represents a different data set from a different source. The BI experts analyze the data, make sense of their visualizations, and typically prepare a report to share with other people. For example, the BI reports may include flashboards and charts. The flashboards and charts may be part of a presentation that the BI expert presents to explain the reports in more detail to various other users.

The reports may include a dashboard that is accompanied by several charts and tables. The reports help monitor aspects of business performance by highlighting key performance indicators (KPIs) that indicate the success of project management and progression of development teams. A BI report may be a single page with only a title and a dashboard. The one-page report summarizes the most important data and can serve as a starting point for longer reports that give more details.

When readers review the BI reports, the readers often have trouble understanding the reports without detailed explanations from the BI expert. Oftentimes, before publishing a new BI report, the BI expert provides an introductory session to all report readers. During this session, the BI expert may explain the entire story and goal of the report using a slide presentation. For example, the BI expert may explain the meaning of each chart, the relations between different KPIs and different charts, and also what sequence to read the report in. The verbal explanations and presentation slides are ways for BI experts to explain their analysis path. During the presentation, the readers may ask questions during or afterwards, which are answered. To capture the question and answer session, the BI experts may further create Wild pages that include more explanation based on the follow-up questions. A session recording of the presentation, the Wiki page, and the presentation slides are then made available to potential readers.

Although the above may help readers to better understand the BI reports, it requires the BI expert to manually create a presentation and then give the presentation, which all are additional responsibilities on top of the time taken to create the BI report. Further, the presentation, Wiki page, and recording may still not answer all of the questions for any future readers that did not participate in the presentation and did not have a chance to ask questions of the BI expert.

### SUMMARY

In one embodiment, a method creates a story from business intelligence visualizations. The method displays a set of visualizations associated with a business intelligence system on a business intelligence dashboard where the business intelligence dashboard is used to create a business intelligence report. Also, the method receives a set of annotations that are associated with one or more visualizations in the set of visualizations through the dashboard and stores the set of annotations with links to the one or more visualizations. Then, a narrative board is generated for the story including at least a portion of the visualizations and the set of annotations. The set of annotations on the narrative board are displayed visually in the narrative board with a visual relationship to respective visualizations based on respective links to the visualizations to form the story.

In one embodiment, a non-transitory computer-readable storage medium is provided containing instructions for creating a story from business intelligence visualizations, the instructions, when executed, control a computer system to be configured for: displaying a set of visualizations associated with a business intelligence system on a business intelligence dashboard, wherein the business intelligence dashboard is used to create a business intelligence report; receiving a set of annotations that are associated with one or more visualizations in the set of visualizations through the dashboard; storing the set of annotations with links to the one or more visualizations; and generating a narrative board for the story including at least a portion of the visualizations and the set of annotations, wherein the set of annotations on the narrative board are displayed visually in the narrative board with a visual relationship to respective visualizations based on respective links to the visualizations to form the story.

In one embodiment, an apparatus is provided configured to create a story from business intelligence visualizations, the apparatus comprising: one or more computer processors; and a non-transitory computer-readable storage medium comprising instructions, that when executed, control the one or more computer processors to be configured for: displaying a set of visualizations associated with a business intelligence system on a business intelligence dashboard, wherein the business intelligence dashboard is used to create a business intelligence report; receiving a set of annotations that are associated with one or more visualizations in the set of visualizations through the dashboard; storing the set of annotations with links to the one or more visualizations; and generating a narrative board for the story including at least a portion of the visualizations and the set of annotations, wherein the set of annotations on the narrative board are displayed visually in the narrative board with a visual relationship to respective visualizations based on respective links to the visualizations to form the story.

The following detailed description and accompanying drawings provide a better understanding of the nature and advantages of particular embodiments.

### BRIEF DESCRIPTION OF THE DRAWINGS

FIG. 1 depicts an example of a computing system for creating a story from business intelligence information according to one embodiment.

FIG. 2 depicts a simplified flowchart for creating annotations according to one embodiment.

FIG. 3 depicts an example of a dashboard according to one embodiment.

FIG. 4 depicts a simplified flowchart of a method for generating a story according to one embodiment.

FIG. 5 shows an example of a narrative board according to one embodiment.

FIG. 6 shows an example of a zoomed-in interface.

FIG. 7 shows an example of a fade mode according to one embodiment.

FIG. 8 illustrates hardware of a special purpose computing machine configured with a story creation system for business intelligence information according to one embodiment.

### DETAILED DESCRIPTION

Described herein are techniques for a story creation system using business intelligence information. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

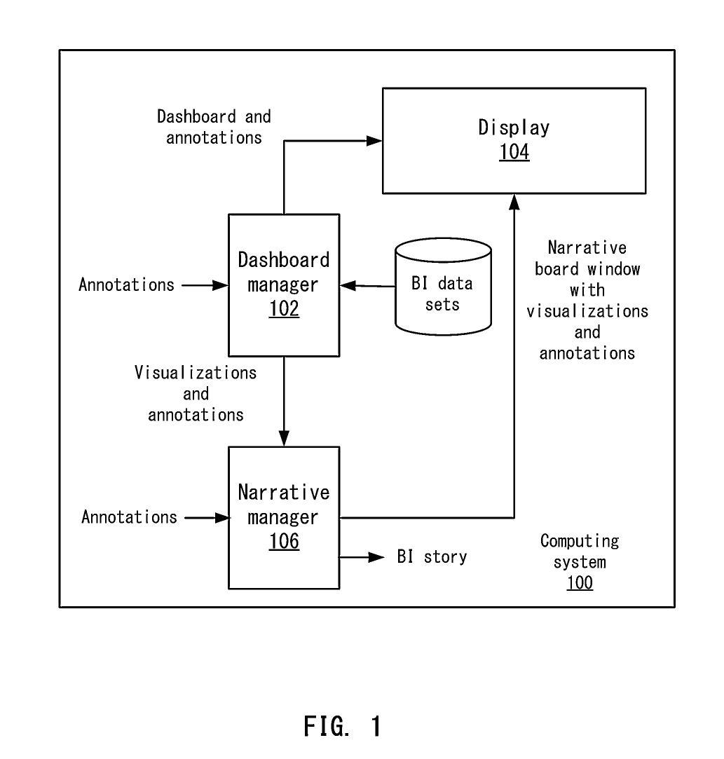

FIG. 1 depicts an example of a computing system 100 for creating a story from business intelligence information according to one embodiment. A dashboard manager 102 provides an analysis dashboard to a user through a display 104. The dashboard may include various visualizations of business intelligence data, such as a collection of coordinated (synchronized) charts connecting one or more data sets retrieved from storage 105. The dashboard also provides advanced exploration capabilities, such as data selection and filtering, and online analytical processing (OLAP) functionality (e.g., drill-up/drill-down functionalities). Dashboard manager 102 creates the visualizations from different data sets. Typically, a user would create a BI report through the dashboard by organizing various visualizations.

Particular embodiments allow a user to create annotations on “data targets”, which may be visualizations including charts, tables (e.g., a bar or pie chart), or parts of them (e.g., a specific bar or slice in the chart). The annotation may include information, such as textual information or other visualizations, that describes the data target. For example, the user may choose to annotate a chart to describe the subject matter the chart is analyzing. The annotation may also include other information, such as other charts, links, etc. In one embodiment, dashboard manager 102 highlights the annotated data targets in the dashboard and includes an icon that indicates a number of attached annotations per data target. Dashboard manager 102 also displays a list of annotations in addition to the visualizations.

After or during conducting analysis on the dashboard, the user may decide to create a story. Previously, dashboard manager 106 may have received various annotations for the BI report. After which, dashboard manager 106 receives a selection from the user to create a story. In this case, the dashboard may be display a create story icon that the user can select. When the create story icon is selected, a narrative manager 106 opens up a narrative board window. To generate the narrative board, narrative manager 106 may determine the visualizations and associated annotations (e.g., annotation text and data targets) and place the visualizations and annotations on the narrative board. In one embodiment, because dashboards can present evolving data, but a story can be an instance in time, by default narrative manager 106 places each visualization on the narrative board with a time stamp to indicate when the visualization was taken from the data.

From the narrative board window, users may create a BI story. The narrative board window displays visualizations and annotations from the dashboard. For example, a user may select the most important visualizations to include in the BI story. The annotations help the reader understand these visualizations and ultimately the whole BI report. Narrative manager 106 arranges the visualizations and annotations based on how the annotations were inserted in the dashboard. For example, annotations are places near associated visualizations with various relational connectors, which will be described in more detail below.

In the narrative board window, users can resize and relocate all story entities freely or choose to organize them using other narrative templates. Also, the users can edit visualization titles, annotations of data targets, and add new annotations. Additionally, users can add visual entities that indicate relations, grouping, and emphasis to help create the story using available creation tools. In one embodiment, the story can be seen in a static representation where all entities remain on one screen or in another embodiment, in a playback representation where entities are highlighted sequentially according to an author-defined sequence. When finished with the creating the story, narrative manager 106 can output the BI story. The BI story is a collection of visual representations of the most important data followed by further data details (BI report), accompanied by instructions on how to read the visualizations (order, connections, importance) in the form of presentations and verbal or textual instructions on a wiki. Although the user presents a desired way to view data through the story, this structure is not enforced: the audience can pursue the story in a different sequence and dig for data details in the report. Thus a BI story differs from a simple fixed sequence presentation that prohibits exploration. Its goal is to communicate analysis findings and supporting evidence.

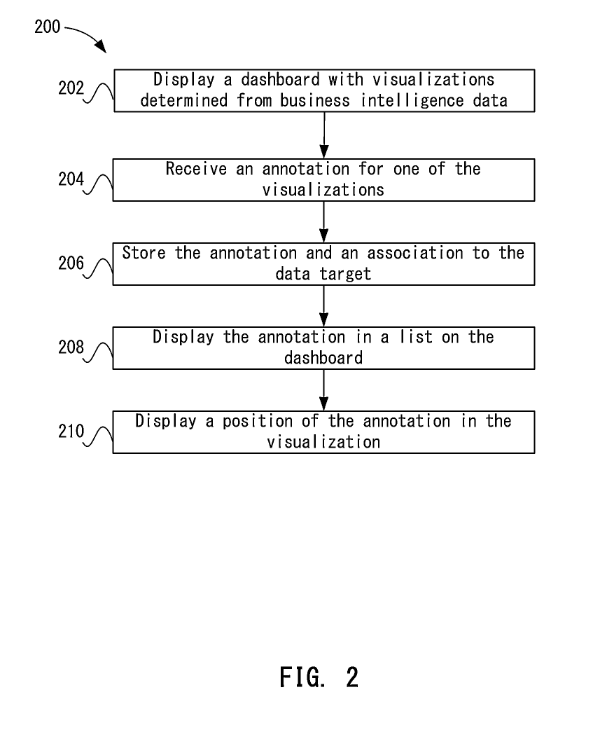

FIG. 2 depicts a simplified flowchart 200 for creating annotations according to one embodiment. At 202, dashboard manager 102 displays a dashboard with visualizations determined from business intelligence data sets. A user may then analyze various visualizations on the dashboard and decide to insert annotations. At 204, dashboard manager 102 receives an annotation for one of the visualizations. For example, a user may select a data target in the dashboard, which may be a position on one of the visualizations. Then, the user may input information for the annotation, such as a description describing the data target. This description may serve to guide the user in reading the BI report.

At 206, dashboard manager 102 stores the annotation and an association to the data target. For example, the annotation is stored with a link to the data target, which may be the visualization or a point in the visualization.

At 208, dashboard manager 102 displays the annotation in a list on the dashboard. For example, the list may be located to the side of the visualizations on the dashboard. The list allows the user to see the annotations that have been created and also enter textual information for the annotations in the list.

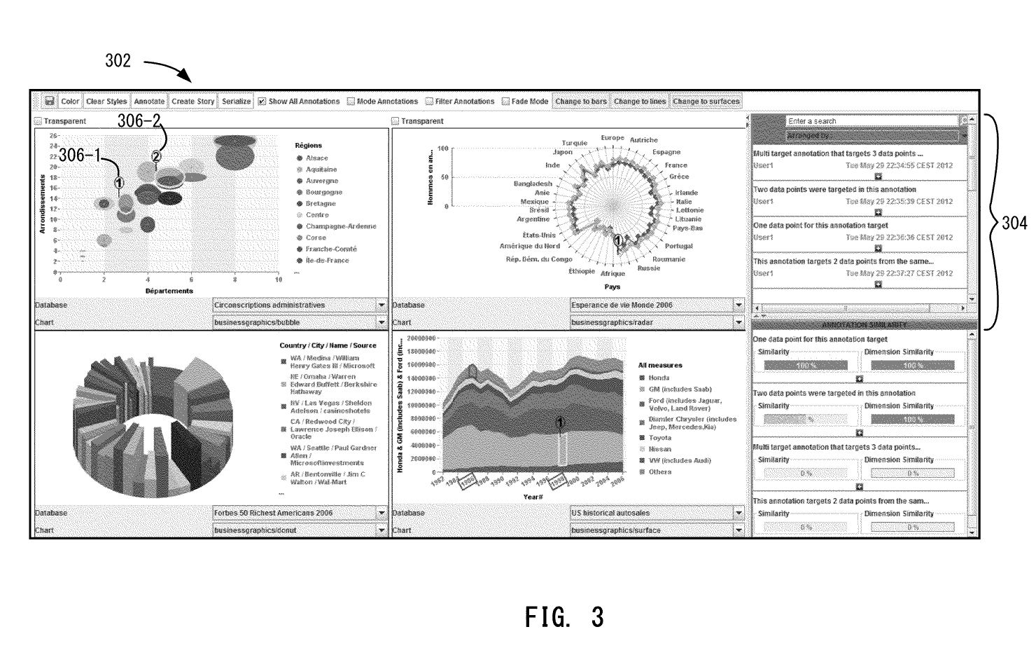

At 210, dashboard manager 102 displays a position of the annotation in the visualization. For example, dashboard manager 102 may insert identifiers for each annotation in the list indicating the positions of the annotations. FIG. 3 depicts an example of a dashboard according to one embodiment. At 302, a dashboard is shown, and at 304, a list of annotations is shown. At 306-1 and 306-2, identifiers for annotations are shown in the visualizations. The identifiers correspond to annotations in the list.

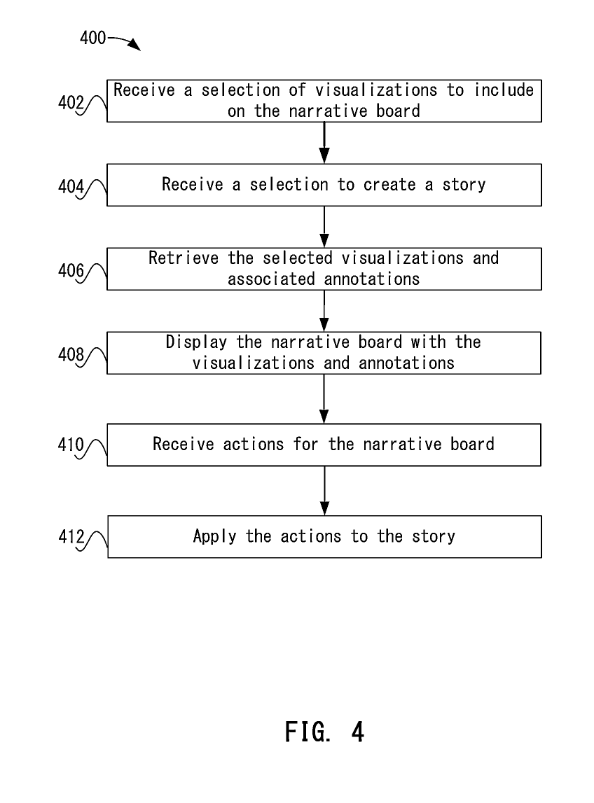

FIG. 4 depicts a simplified flowchart 400 of a method for generating a story according to one embodiment. At 402, narrative manager 106 receives a selection of visualizations to include on the narrative board. For example, a user may select which visualizations from the dashboard to include in the narrative board. In one embodiment, by default, all visualizations shown in the dashboard when a create story input is received may be included on the narrative board.

At 404, narrative manager 106 receives a selection to create a story. For example, the user may select a create story icon on the dashboard. This integrates the dashboard with the narrative board. At 406, narrative manager 106 retrieves the selected visualizations and associated annotations. For example, narrative manager 106 determines for each selected visualization included on the narrative board, any associated annotations that were added in the dashboard. For example, dashboard manager 102 may have stored annotations with links to the associated visualizations.

At 408, narrative manager 106 displays the narrative board with the visualizations and annotations. This displays the story created by the user. Any components that appear on the narrative board (visualization charts, visual symbols, annotations) are individual objects, and are presented in a side bar. At 410, narrative manager 106 receives actions for the narrative board. The actions may include editing the visualizations or annotations, adding entities to the story, or rearranging entities in the story. For example the following actions can be performed with the objects: delete an object; edit the title of an object, add descriptive text to an object; resize and locate an object on the narrative board by drag & drop; specify an order for each object, edit the sequence of object appearance in the story through time; and specify a playback focus time for each item on the story board. At 412, narrative manager 106 applies the actions to the story.

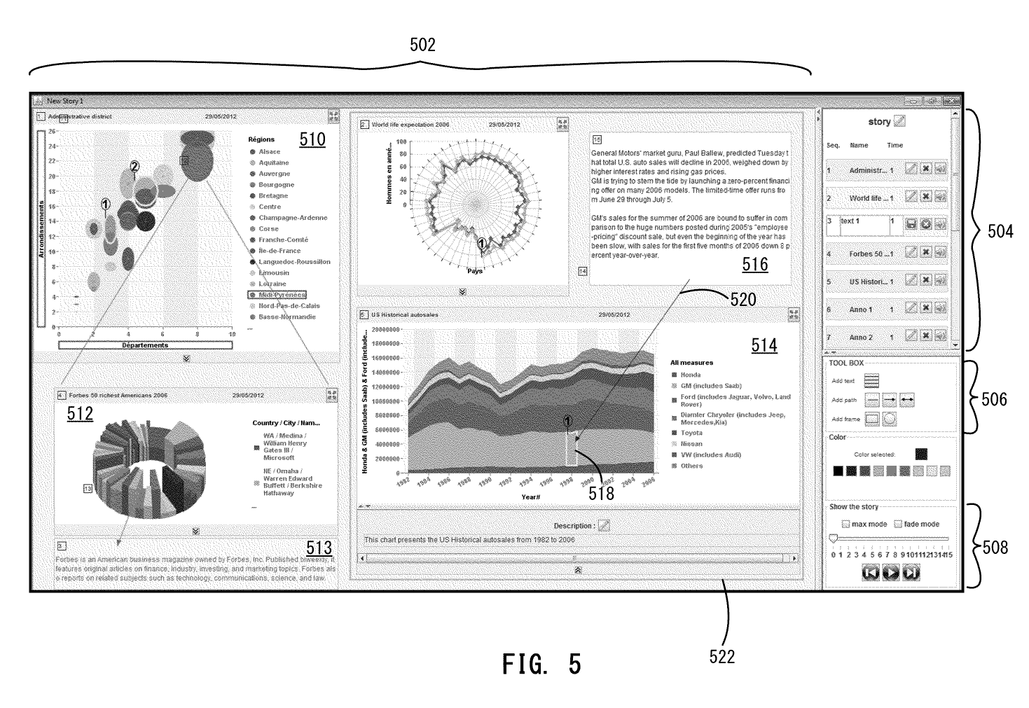

FIG. 5 shows an example of a narrative board 500 according to one embodiment. A section 502 shows story entities arranged by the user including visualizations and annotations. A section 504 shows the objects for the story. For example, this section lists the visualizations and annotations. A section 506 provides a toolbox that allows a user to add relational and organizational entities. A section 508 allows the user to control playback of the story through a story timeline.

Referring back to section 502, a first visualization 510 is shown. An annotation 512 to the visualization describes the data target for the annotation. For example, annotation 512 provides more information about Forbes. Additionally, annotation 512 includes another annotation 513 that is associated with a portion of a chart shown in annotation 512. For example, annotation 513 describes a slice of the chart shown in annotation 512. A visualization 514 also includes an annotation 516. Annotation 516 is associated with a particular point of visualization 514. For example, at 518, annotation 516 describes a portion of the chart about the sales of cars for that point in the chart.

In one embodiment, the narrative board may include the following entities:
1. Information entities: These entities include visualizations, text, and annotations. These are mainly imported visualizations and annotations created during the analysis using the dashboard. For annotated visualizations, the annotation text, the visualization, as well as the annotated data target (e.g., specific part of the visualization that is annotated) is included. FIG. 3 shows the dashboard with visualizations created during analysis on the left, and list of annotations added to different data contexts while exploring analysis visualizations on the right.
2. Relational entities: These entities include arrows, lines, and HyperText Markup Language (HTML) links. A story can include relationships between entities, such as causality. The narrative board provides visual arrows, lines, HTML links and other vectorial references to define relations between entities as shown at 506 in FIG. 5. One example of a relational entity is shown by an arrow 520 that relates annotation 516 to visualization 514 in FIG. 5. Arrow 520 is a graphical aid that presents a relationship between annotation 516 and visualization 514.
3. Organization entities: These entities include visual grouping and sequences. The narrative board shows a visual grouping of entities that are to be seen together in a story. The narrative board defines the groupings using entity grouping borders. The groupings show a dependency between visualization within a grouping. Also, the narrative board defines a reading sequence for each entity, to help readers move through the story. The narrative board achieves this by allowing users to define the order of appearance of all entities through a sequence list in section 504. Here, users can change the entity's sequence in the list, delete, or rename any entity. The sequence guides the user on how to read visualizations and in what order. Further, as discussed below, the story presentation may use a static view (with sequence numbers) or a playback view (e.g., highlight, maximize, or fade out options) to guide the reader through the story. The users can also define a playback time for each entity, a time for the entity to be in focus in the playback presentation mode. Audio can also be recorded for any entity, to be played when the reader watches the story playback.
4. Emphasis entities: These entities include highlighting and zooming. To focus the reader's attention to a specific story entity, users can add color highlights to any entity (e.g. a visualization, an arrow, or text entity), or select and highlight parts of visualizations (e.g., a bar in a bar chart visualization). This color highlighting can be present in the static story presentation (always visible), or during playback (the color highlight appears at a specific point in the story timeline). Besides color highlighting, users can add zooming highlighting to any story entity that will take place in a specific point in time during playback. The narrative board shows one example of a grouping at 522. Although the above entities are discussed, particular embodiments may use other entities.

As discussed above, the narrative board window provides multiple ways of displaying users' stories to readers. For example, a static overview version of the story provides context and allows free exploration of entities. This allows a user to interact with the story. For example, a user may drill up or drill down into data targets. Further, annotations may be drilled up or down. Also, a playback of the story shows a recording of the author-suggested path.

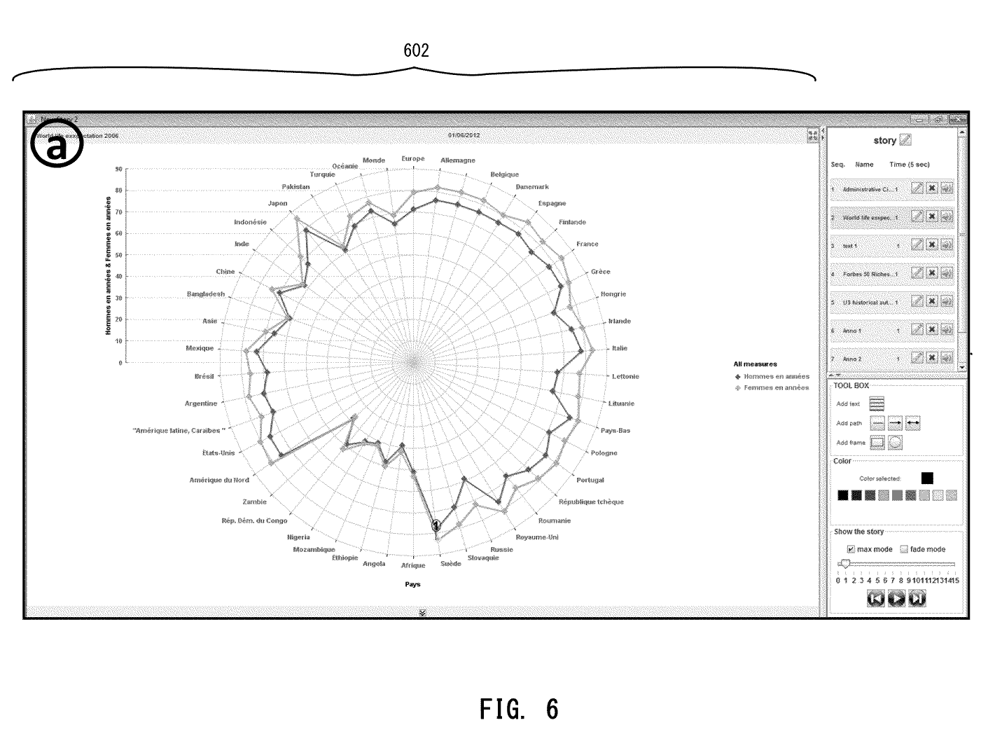

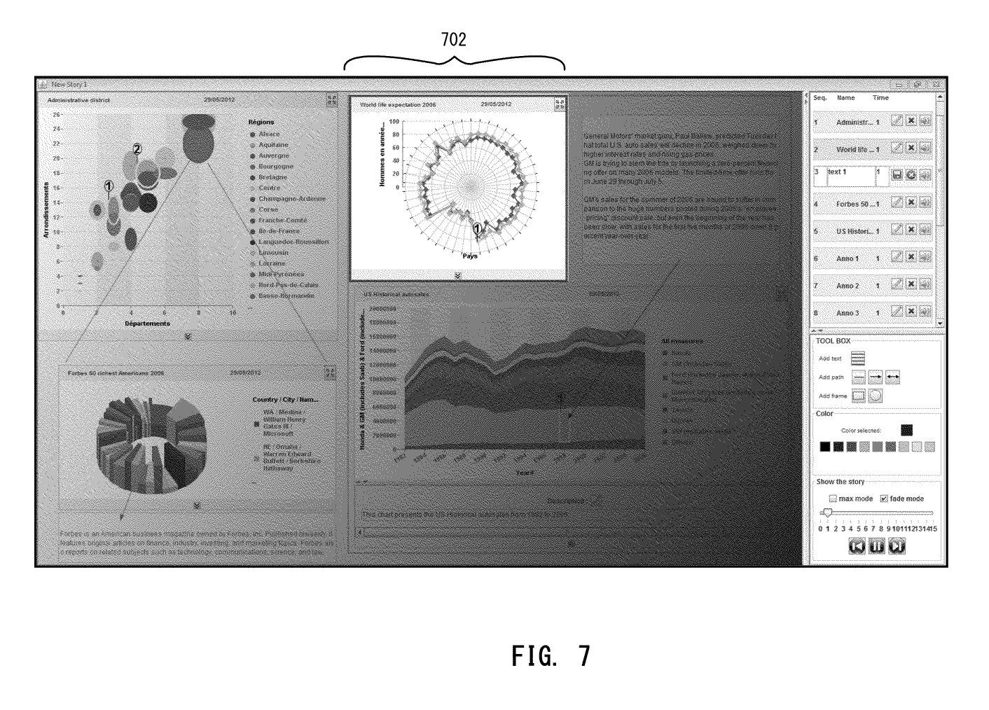

In animated playback, three options may be provided that give focus to entities in sequence for a given duration. This provides sequence for the reader and guides the reader in which visualizations to focus on. In a “color highlight” playback mode, entities that are in focus change color to grab attention. In a “max” playback mode, entities in focus are zoomed in to the maximum possible size taking up the entire narrative board. FIG. 6 shows an example of a zoomed-in interface. In a section 602, a visualization has been zoomed in to a maximum possible size that takes up the entire narrative board. Finally, in a “fade mode”, during playback, all entities except the entities in focus fade out. FIG. 7 shows an example of a fade mode according to one embodiment. At 702, the narrative board has been focused on a single visualization. Also, other visualizations have been faded out. Users can also record audio to accompany the playback of entities and readers can pause the playback at any time to explore the story.

Accordingly, particular embodiments provide users with the ability to create stories from a dashboard. The stories include annotations that may explain visualizations in the BI report. The automatic story creation is used to provide stories that explain BI reports.

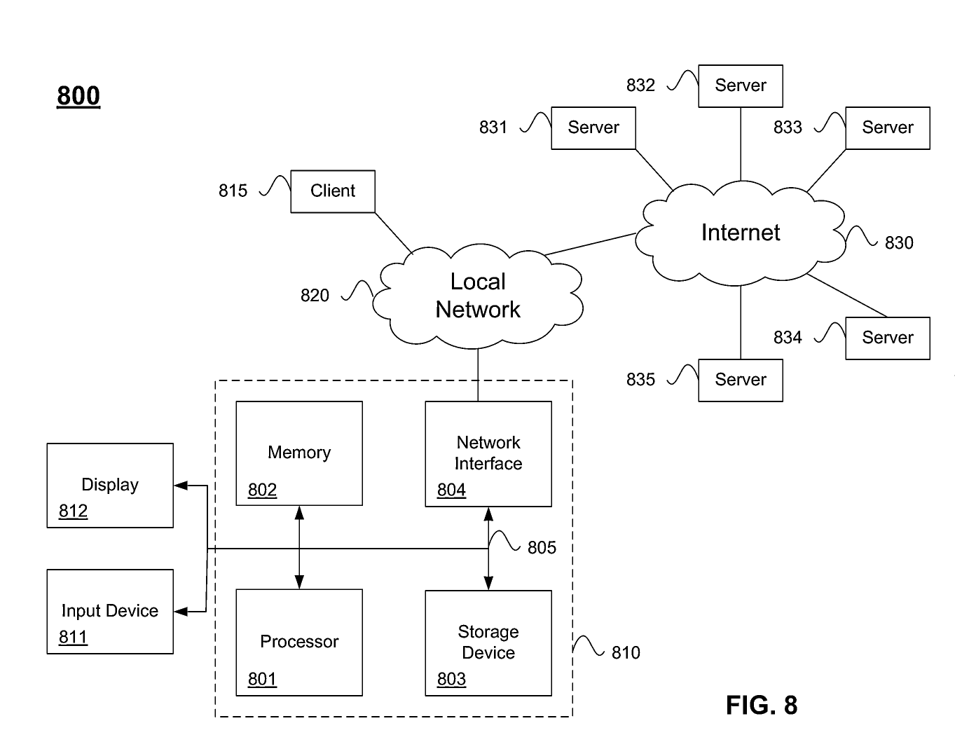

FIG. 8 illustrates hardware of a special purpose computing machine configured with a story creation system for business intelligence information according to one embodiment. An example computer system 810 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable storage mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information through the network interface 804 across a local network 820, an Intranet, or the Internet 830. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method for creating a story from business intelligence visualizations, the method comprising:
displaying, by a computing device, a set of visualizations associated with a business intelligence system on a business intelligence dashboard, wherein the business intelligence dashboard is used to create a business intelligence report;
receiving, by the computing device, a set of annotations that are associated with one or more visualizations in the set of visualizations through the dashboard;
storing, by the computing device, the set of annotations with links to the one or more visualizations; and
generating, by the computing device, a narrative board for the story including at least a portion of the visualizations and the set of annotations, wherein the set of annotations on the narrative board are displayed visually in the narrative board with a visual relationship to respective visualizations based on respective links to the visualizations to form the story.

2. The method of claim 1, wherein the story is created automatically from the dashboard.

3. The method of claim 1, further comprising:
receiving a selection of the least a portion of the visualizations to include in the narrative board; and
generating the narrative board with the selection of visualizations.

4. The method of claim 1, wherein receiving the set of annotations comprises:
receiving an indication of which visualization to include an annotation;
receiving information for the annotation; and
storing a link between the annotation and the visualization along with the information.

5. The method of claim 4, wherein the link includes a position in the visualization in which to visually associate the annotation.

6. The method of claim 5, wherein the narrative board displays the annotation with the visual relationship to the position in the visualization.

7. The method of claim 1, further comprising displaying the set of annotations in a list associated with the dashboard and a positional indicator in the set of visualizations for respective annotations in the set of annotations.

8. The method of claim 1, wherein the story includes a time-based sequence of the at least a portion of the visualizations and the set of annotations in the story.

9. The method of claim 1, wherein the story includes a static representation of the at least a portion of the visualizations and the set of annotations in the story.

10. The method of claim 1, further comprising:
receiving an adjustment to one of the set of annotations that is displayed visually in the narrative board with the visual relationship; and
adjusting the annotation or the visual relationship for the visualization based on the adjustment.

11. A non-transitory computer-readable storage medium containing instructions for creating a story from business intelligence visualizations, the instructions, when executed, control a computer system to be configured for:
displaying a set of visualizations associated with a business intelligence system on a business intelligence dashboard, wherein the business intelligence dashboard is used to create a business intelligence report;
receiving a set of annotations that are associated with one or more visualizations in the set of visualizations through the dashboard;
storing the set of annotations with links to the one or more visualizations; and
generating a narrative board for the story including at least a portion of the visualizations and the set of annotations, wherein the set of annotations on the narrative board are displayed visually in the narrative board with a visual relationship to respective visualizations based on respective links to the visualizations to form the story.

12. The non-transitory computer-readable storage medium of claim 11, wherein the story is created automatically from the dashboard.

13. The non-transitory computer-readable storage medium of claim 11, further configured for:
receiving a selection of the least a portion of the visualizations to include in the narrative board; and
generating the narrative board with the selection of visualizations.

14. The non-transitory computer-readable storage medium of claim 11, wherein receiving the set of annotations comprises:
receiving an indication of which visualization to include an annotation;
receiving information for the annotation; and
storing a link between the annotation and the visualization along with the information.

15. The non-transitory computer-readable storage medium of claim 14, wherein the link includes a position in the visualization in which to visually associate the annotation.

16. The non-transitory computer-readable storage medium of claim 15, wherein the narrative board displays the annotation with the visual relationship to the position in the visualization.

17. The non-transitory computer-readable storage medium of claim 11, further configured for displaying the set of annotations in a list associated with the dashboard and a positional indicator in the set of visualizations for respective annotations in the set of annotations.

18. The non-transitory computer-readable storage medium of claim 11, wherein the story includes a time-based sequence of the at least a portion of the visualizations and the set of annotations in the story.

19. The non-transitory computer-readable storage medium of claim 11, wherein the story includes a static representation of the at least a portion of the visualizations and the set of annotations in the story.

20. An apparatus configured to create a story from business intelligence visualizations, the apparatus comprising:
one or more computer processors; and
a non-transitory computer-readable storage medium comprising instructions, that when executed, control the one or more computer processors to be configured for:
displaying a set of visualizations associated with a business intelligence system on a business intelligence dashboard, wherein the business intelligence dashboard is used to create a business intelligence report;
receiving a set of annotations that are associated with one or more visualizations in the set of visualizations through the dashboard;
storing the set of annotations with links to the one or more visualizations; and
generating a narrative board for the story including at least a portion of the visualizations and the set of annotations, wherein the set of annotations on the narrative board are displayed visually in the narrative board with a visual relationship to respective visualizations based on respective links to the visualizations to form the story.
